(19) United States
(12) Patent Application Publication
(10) Pub. No.: US 2009/0087739 A1
(43) Pub. Date: Apr. 2, 2009

(54) NON-AQUEOUS ELECTROLYTE SECONDARY BATTERY, METHOD FOR PRODUCING THE SAME, AND METHOD FOR MOUNTING THE SAME

(76) Inventor: Tadayoshi Takahashi, Osaka (JP)

Correspondence Address: MCDERMOTT WILL & EMERY LLP, 600 13TH STREET, NW, WASHINGTON, DC, 20005-3096, US

(21) Appl. No.: 11/917,545

(22) PCT Filed: Jan. 17, 2007
(86) PCT No.: PCT/JP2007/050578

§ 371 Date: Dec. 14, 2007

(30) Foreign Application Priority Data
Jan. 25, 2006 (JP) 2006-015910

(51) Int. Cl. H01M 10/40; H01M 4/36; H01M 4/48; H01M 6/00

(52) U.S. Cl. 429/188; 429/209; 429/231.1; 429/231.3; 29/623.1

(57) ABSTRACT

A non-aqueous electrolyte secondary battery includes a positive electrode, a negative electrode, and a non-aqueous electrolyte interposed between the positive electrode and the negative electrode. The positive electrode includes an active material capable of reversibly absorbing and desorbing lithium. The negative electrode includes an active material of the same composition as that of the active material of the positive electrode. This non-aqueous electrolyte secondary battery does not generate voltage until being charged. Also, in the case of reflow mounting, charging the battery after mounting will avoid having an adverse effect on the components mounted on the substrate.

### TECHNICAL FIELD

The present invention relates to a non-aqueous electrolyte secondary battery that can withstand an external short-circuit and reverse charging and can be easily mounted on a substrate.

### BACKGROUND ART

Lithium secondary batteries are widely used as main power sources for portable appliances, backup power sources, etc. In lithium secondary batteries in backup applications, for example, a lithium aluminum alloy is used as an active material in a negative electrode, while vanadium pentoxide, a lithium-containing manganese oxide, or niobium pentoxide is used as an active material in a positive electrode. Also, in lithium ion secondary batteries in main power source applications, for example, graphite or spinel-type lithium titanate is used in a negative electrode, while lithium cobaltate is used in a positive electrode. When backup lithium secondary batteries are assembled, they exhibit voltages of about 3 V. When lithium ion secondary batteries in main power source applications are assembled, their voltages are about 0.2 to 0.3 V, and when charged, they exhibit predetermined voltages such as 4 V and 2.5 V.

In the event that lithium secondary batteries exhibiting voltages of about 3 V at the time of battery assembly are externally short-circuited, a current flows therethrough and their performance significantly deteriorates. Also, even in the case of lithium ion secondary batteries having almost no voltage at the time of assembly, upon an external short-circuit, their battery performance degrades due to corrosion reaction of current collectors and exterior cans and structural deterioration of active materials. In addition, when lithium ion secondary batteries are charged, they have a high voltage of 4 V. It is thus necessary when producing batteries to give consideration so as not to cause an external short-circuit between the positive electrode and the negative electrode.

Also, when common secondary batteries are mistakenly charged with the polarities of positive and negative electrodes reversed, their battery performance significantly lowers due to deterioration of electrode materials, corrosion of exterior cans and current collectors, decomposition of electrolyte, etc. In some cases, leakage occurs, thereby causing corrosion of other nearby components and damaging devices themselves. Hence, for example, the structure of devices is designed so as to prevent reverse charging.

Backup lithium secondary batteries are mainly in coin form. Such a battery is manually soldered to a substrate on which most components have been mounted by reflowing, or is inserted into a battery holder. Patent Document 1 proposes a battery that can be mounted by reflow automatic mounting in which the battery is exposed to temperatures of 230 to 250° C., although for several seconds, by enhancing the heat resistance of the respective materials. However, when a battery is soldered to a substrate by reflowing for circuit connection, a current flows at high temperatures of 150° C. or more since the battery has a voltage of about 3 V. This may adversely affect the performance of other components. Further, since the resistance decreases at high temperatures, a larger current than actual one (at room temperature) could flow. Also, in some cases, a large current beyond battery performance may flow, thereby resulting in significant degradation of battery performance.

It is therefore necessary to arrange components or apply a special structure so that a current does not flow thorough a substrate to which a battery is being soldered during reflowing. In this way, the problem of a current flowing due to a battery during reflow mounting has been addressed on the device side.

On the other hand, a method to address this problem on the battery side can be completely discharging a lithium secondary battery to 0 V. However, since making the voltage to almost 0 V is very difficult and takes a very long time, it is difficult to incorporate such a step into a production process. Also, there is no battery whose characteristics do not deteriorate even in the event of an external short-circuit, and it is thus difficult to make the battery production process more efficient or simpler. In addition, there is no battery that is stable even when charged reversely or the like, and consideration is given with respect to charging in designing devices.

### Patent Document 1: Japanese Laid-Open Patent Publication No.

### DISCLOSURE OF INVENTION

The non-aqueous electrolyte secondary battery of the present invention includes a positive electrode, a negative electrode, and a non-aqueous electrolyte interposed between the positive electrode and the negative electrode. The positive electrode includes an active material capable of reversibly absorbing and desorbing lithium. The negative electrode includes an active material of the same composition as that of the active material of the positive electrode. Since such a non-aqueous electrolyte secondary battery is resistant to deterioration in characteristics even if externally short-circuited, it can be produced more easily. Also, it is stable even if charged reversely. Further, since almost no current flows during reflow mounting, there is no need to design a substrate having a special structure. This non-aqueous electrolyte secondary battery does not generate voltage until being charged. Also, in the case of reflow mounting, charging the battery after mounting will avoid having an adverse effect on the components mounted on the substrate.

### BRIEF DESCRIPTION OF DRAWINGS

FIG. 1 is a cross-sectional view of a coin battery, which is a non-aqueous electrolyte secondary battery in an embodiment of the present invention; and

FIG. 2 is a cross-sectional view of a symmetrical battery, which is a non-aqueous electrolyte secondary battery in an embodiment of the present invention.

### EXPLANATION OF REFERENCE CHARACTERS

1 Positive electrode can
2 Negative electrode can
3 Gasket
4 Positive electrode
5 Negative electrode
6 Separator
7A, 7C Current collector
9 Exterior can
10 Insulating sealing member
11 Electrode
12 Separator

### BEST MODE FOR CARRYING OUT THE INVENTION

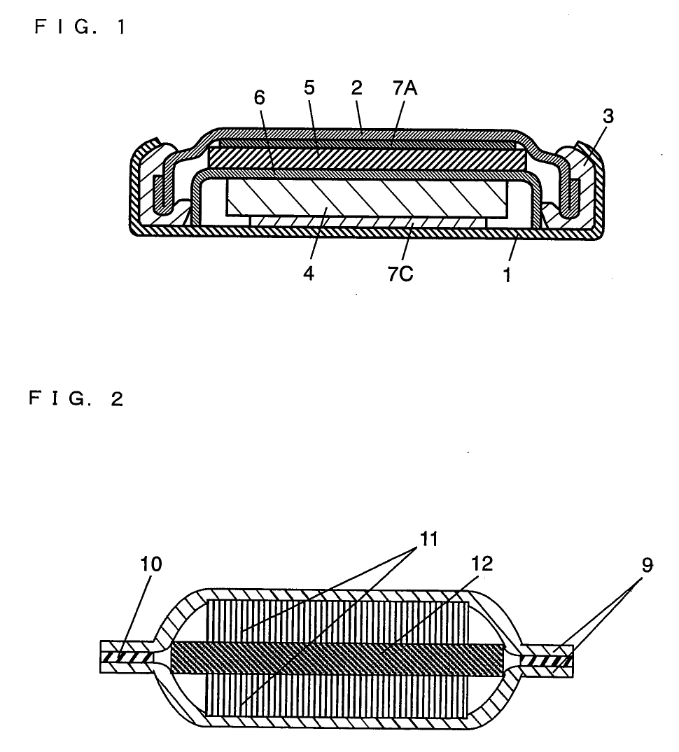

FIG. 1 is a cross-sectional view of a coin battery, which is a non-aqueous electrolyte secondary battery in an embodiment of the present invention. This battery has a positive electrode 4, a negative electrode 5, and a non-aqueous electrolyte, not shown, which is interposed between the positive electrode 4 and the negative electrode 5. The positive electrode 4 is bonded to a positive electrode can 1 with a current collector 7C (conductive carbon) interposed therebetween. The negative electrode 5 is also bonded to a negative electrode can 2 with a current collector 7A (conductive carbon) interposed therebetween. The positive electrode 4 and the negative electrode 5 are laminated with a separator 6 interposed therebetween, and the separator 6 contains an organic electrolyte, which is a non-aqueous electrolyte. The positive electrode can 1 is combined with the negative electrode can 2 with a gasket 3 interposed therebetween, followed by crimping. The positive electrode can 1 and the negative electrode can 2 form exterior cans which seal the positive electrode 4, the negative electrode 5, the non-aqueous electrolyte, and the like.

The separator 6 can be a micro-porous film or non-woven fabric made only of polypropylene or polyethylene, a micro-porous film or non-woven fabric made of a mixture thereof, a non-woven fabric made of polyphenylene sulfide, a glass fiber separator, a cellulose separator, etc.

The organic electrolyte can be prepared by dissolving a solute of LiPF₆, LiBF₄, LiClO₄, LiN(CF₃SO₂)₂, or LiN(C₂F₅SO₂)₂ in a single solvent or solvent mixture composed of one or more of ethylene carbonate, propylene carbonate, butylene carbonate, γ-butyrolactone, sulfolane, 3-methylsulfolane, methyl tetraglyme, 1,2-dimethoxyethane, methyl diglyme, methyl triglyme, butyl diglyme, dimethyl carbonate, ethyl methyl carbonate, and diethyl carbonate. For batteries that are to be exposed to high-temperature reflowing at 230 to 250° C., it is preferable to use a solvent containing at least one of sulfolane, 3-methylsulfolane, and methyl tetraglyme, which have boiling points of 270° C. or more.

Also, the non-aqueous electrolyte may be a solid electrolyte. The solid electrolyte may be a polymer solid electrolyte or an inorganic solid electrolyte. The polymer solid electrolyte can be polyethylene oxide (PEO), polymethyl methacrylate (PMMA), or polyvinylidene fluoride (PVDF) containing LiN(CF₃SO₂)₂ as a solute, or a gelled electrolyte containing such an organic solvent as described above. Also, the inorganic solid electrolyte can be a lithium-containing metal oxide glass, such as LiPON (Lithium Phosphorus Nitride) or Li₁₄Zn(GeO₄)₄, or a lithium-containing sulfide, such as Li₂S-SiS₂, thio-LISICON, etc. In the case of using a solid electrolyte, the separator 6 is not always necessary.

Right after this battery is assembled, the positive electrode 4 and the negative electrode 5 contain an active material of the same composition. That is, the positive electrode 4 contains an active material capable of reversibly absorbing and desorbing lithium, and the negative electrode 5 contains an active material of the same composition as that of the active material of the positive electrode 5.

When the positive electrode 4 and the negative electrode 5 have the same electrode composition, the voltage at the time of battery assembly is a value almost equal to 0 V. Then, by charging the positive electrode 4 and the negative electrode 5, lithium contained in the active material of the positive electrode 4 is extracted from the positive electrode 4. On the other hand, the active material contained in the negative electrode 5 absorbs lithium from the non-aqueous electrolyte. In this way, when charged, the battery generates a voltage due to a change in the lithium composition ratios in the active materials of the positive electrode 4 and the negative electrode 5.

The non-aqueous electrolyte secondary battery according to this embodiment is resistant to deterioration in characteristics even if externally short-circuited immediately after the assembly. Hence, in cases where voltage is not necessary until the battery is mounted on a device, the production process can be made simpler and more efficient without worrying about performance deterioration due to an external short-circuit or the like, so that the productivity is significantly improved. Also, for example, in connecting a terminal to the battery, a major process modification is possible without worrying about an external short-circuit, so that product accuracy and the like are greatly improved. In addition, defects which often occur due to external short-circuits or the like are reduced and the fraction defective can also be lowered. Further, in the event of reverse charging, problems such as severe deterioration and leakage do not occur, since the positive electrode 4 and the negative electrode 5 have the same configuration. Furthermore, in the case of reflow mounting, almost no current flows, and there is thus no need to design a substrate having a special structure. It should be noted that even after a battery is charged/discharged, if it is discharged until the voltage drops to 0.1 V or less, essentially the same effects can be obtained.

The active material can be a lithium-containing transition metal oxide capable of lithium insertion/extraction. Further, the active material may also be a lithium-containing transition metal oxide having sites capable of lithium insertion/extraction, or may be a mixture of such an oxide and a transition metal oxide having sites capable of lithium insertion/extraction.

It is particularly preferable that the active material include a lithium-containing manganese oxide. Lithium-containing manganese oxides are capable of reversible insertion/extraction of the lithium they contain, and in addition, they can absorb lithium in amounts that are greater than the amounts of lithium they contain stably in air.

Examples of lithium-containing manganese oxides include lithiated ramsdellite-type manganese dioxide, orthorhombic Li_{0.44}MnO₂, spinel-type Li_{1+X}Mn_{2-X}O₄(0≦X≦0.33), and spinel-type Li_{1+X}Mn_{2-X-y}AO₄ (where A is Cr, Ni, Co, Fe, Al, or B, 0≦X≦0.33, 0<y≦0.25) in which part of the manganese is replaced with a different element.

Depending on composition ratio and baking conditions such as baking temperature, it is also possible to produce a mixed crystal of lithium-containing manganese oxides. By using such a mixed crystal or forming a simple mixture of two or more lithium-containing manganese oxides, it is possible to vary charge/discharge voltage characteristics.

Also, the active material preferably includes at least one of LiCo₂, LiNiO₂, LiNiₓCO_{1-X}O₂ (0<x<1), and LiCo_{1/3}Ni_{1/3}Mn_{1/3}O₂. Since such a lithium-containing transition metal oxide can release the lithium it contains, it can be used as a lithium supply source for reaction. If it is mixed with a lithium-containing manganese oxide, it is possible to increase the amount of lithium necessary for reaction and to enlarge the applicable range of charge/discharge conditions.

Also, the above-mentioned lithium-containing transition metal oxide capable of insertion/extraction of the lithium it contains may be mixed with MnO₂, V₂O₅, V₆O₁₃, Nb₂O₅, WO₃, TiO₂, MoO₃, lithium titanate Li_{4/3}Ti_{5/3}O₄, or a substituted form thereof in which part of the Ti element is replaced with a transition metal oxide. Although MnO₂, V₂O₅, V₆O₁₃, Nb₂O₅, WO₃, TiO₂, and MoO₃ do not contain lithium, they are capable of lithium insertion/extraction. Although Li_{4/3}Ti_{5/3}O₄ and substituted forms thereof are lithium-containing transition metal oxides, the lithium contained therein cannot be used for reaction. However, lithium can be inserted thereinto from outside and extracted therefrom. When such a transition metal oxide is mixed, it serves to store lithium during charging and enlarge the applicable range of charge/discharge conditions.

The positive electrode 4 and the negative electrode 5 may contain a conductive agent and a binder in addition to the above-described various active materials. The conductive agent can be graphite, carbon black, acetylene black, vapor-phase growth carbon fiber (VGCF), etc. The binder is preferably a fluorocarbon resin such as polytetrafluoroethylene (PTFE), tetrafluoroethylene-hexafluoropropylene copolymer (FEP), or polyvinylidene fluoride (PVDF), and it is also possible to use a rubber such as styrene butadiene rubber (SBR) or ethylene propylene-diene rubber (EPDM).

In the coin battery illustrated in FIG. 1, the materials of the positive electrode can 1 and the negative electrode can 2, serving as the exterior cans, preferably have the same composition. Since the positive electrode 4 and the negative electrode 5 have the same composition right after the assembly, the voltage is almost equal to 0 V. Thus, in the event of an external short-circuit, almost no current flows. In fact, however, if the materials of the positive electrode can 1 and the negative electrode can 2 are different, a potential difference occurs, although it is only less than 0.1 V, because the stable potentials of the exterior cans themselves are different. Due to the influence of this potential difference, the active material may deteriorate slightly. It is thus more preferable that the positive electrode can 1 and the negative electrode can 2 have the same composition. In this case, the stability increases and the battery voltage becomes closer to 0 V.

The material of the exterior cans is preferably aluminum or an aluminum alloy, and in terms of strength and corrosion resistance, an aluminum alloy is more preferable than pure aluminum. In particular, an aluminum alloy containing manganese, magnesium, or the like is preferred. Also, the use of a cladding material composed of iron or easily workable stainless steel such as SUS304N and aluminum or an aluminum alloy can further increase the strength and corrosion resistance. It should be noted that since iron or easily workable stainless steel such as SUS304N has a low corrosion resistance, it should be disposed so as not to come in contact with electrolyte. Also, plating the surface of such a cladding material with nickel or using a 3-layer cladding material of nickel/stainless steel/aluminum (aluminum alloy) can provide a battery with a low contact resistance.

Also, the exterior cans are preferably made of an alloy containing at least one of iron, nickel, and chromium and having a pitting resistance equivalent of 22 or more. The inclusion of chromium, molybdenum, and nitrogen is very effective for corrosion resistance. The contents thereof determine PRE (Pitting Resistance Equivalent). PRE is defined as % Cr+3.3×% Mo+20×% N and serves as a measure of corrosion resistance in chloride environment. Examples of such stainless steel alloys include SUS444, SUS329J3L, and SUS316. An alloy composed mainly of nickel and chromium may also be used. Since such an alloy has a significantly high strength, it is preferably used for the exterior can. In coin batteries, the exterior cans serve as current collectors. In cylindrical batteries and rectangular batteries, it is preferable to use such an alloy for the exterior can and use aluminum for the current collectors of the positive electrode and the negative electrode. In addition to using aluminum, an aluminum alloy, a cladding material, an alloy containing at least one of iron, nickel, and chromium and having a pitting resistance equivalent of 22 or more and 70 or less, or an alloy composed mainly of nickel and chromium singly, it is also possible to use them in combination.

It is preferable to charge the coin secondary battery of this embodiment after mounting it by reflowing in a discharged state of 0.1 V or less (in an uncharged state or after charge/discharge). Since the battery itself has almost no voltage, almost no current flows through a circuit during the reflow mounting and there is thus no adverse effect on the components mounted on the substrate. The battery generates a voltage only after it is charged with a main power source connected after the mounting. Even in the case of reflow mounting, there is no need to apply a special design, and it is possible to simplify substrate design and reduce the number of components.

The present invention is applicable to not only the coin battery illustrated in FIG. 1 but also a non-aqueous electrolyte secondary battery whose cross-section is shown in FIG. 2 in which the positive electrode can and the negative electrode can are symmetrical. In this battery, the positive electrode can and the negative electrode can form exterior cans 9, in which electrodes 11 of the same composition, weight, and shape are opposed to each other with a separator 12 containing an organic electrolyte interposed therebetween. The exterior cans 9 are sealed with an insulating sealing member 10 made of, for example, polyethylene by thermal welding, to form a symmetrical non-aqueous electrolyte secondary battery.

In this battery, the shape of the positive electrode can and the shape of the negative electrode can are symmetrical. Hence, even when they are set so as to have either polarity, the same discharge capacity can be obtained. In such a symmetrical non-aqueous electrolyte secondary battery, there is no need to initially distinguish between positive and negative electrodes and polarity can be determined freely. This offers a wide choice of connecting methods to devices and thus more freedom of device design or shape. Also, the structure of the battery itself can be simplified, thereby resulting in an improvement in productivity.

In the coin battery illustrated in FIG. 1, the exterior cans, i.e., the positive electrode can 1 and the negative electrode can 2 serve as current collectors. However, in cylindrical batteries and rectangular batteries, a sealing plate with a terminal is joined to an exterior can. Also, a positive electrode and a negative electrode have a current collector and an active material layer formed thereon. Thus, the exterior can, terminal, and current collectors are preferably made of a material as described above, and more preferably have the same composition.

Preferable examples of the present invention are hereinafter described. First, in the coin battery of FIG. 1, using an aluminum cladding material of Ni/SUS304/Al for the positive electrode can 1 and SUS316 for the negative electrode can 2, various active materials were examined, and the results are shown below. First, the production procedure of Battery A is described.

A mixture of LiNO₃ and MnO₂ in a molar ratio of 1:3 was preliminarily baked at 260° C. for 5 hours and then baked at 340° C. for 5 hours, to prepare a lithiated ramsdellite-type manganese oxide. This oxide was mixed with a carbon black conductive agent and a PTFE binder, to prepare an electrode mixture. The mixing ratio was 88:5:7 by weight. This electrode mixture was molded into pellets of 10 mm in diameter under a pressure of 2 ton/cm², and dried at 250° C. in air to obtain the positive electrode 4 and the negative electrode 5. The weight ratio of the positive electrode 4 to the negative electrode 5 was 1.1:1. That is, the weight of the positive electrode 4 was 1.1 times that of the negative electrode 5.

The positive electrode 4 and the negative electrode 5 thus obtained were bonded to the positive electrode can 1 and the negative electrode can 2 with the current collectors 7C and 7A (conductive carbon) therebetween, respectively. A solution of pitch diluted with toluene was applied to the inner circumference of the positive electrode can 1 and the outer circumference of the negative electrode can 2, and the toluene was evaporated to provide the pitch sealant.

The separator 6 made of polypropylene non-woven fabric was disposed on the positive electrode 4, and an organic electrolyte was dropped. The organic electrolyte was prepared by dissolving LiPF₆ at 1 mol/L (M) in a solvent mixture of ethylene carbonate (EC) and dimethyl carbonate (DMC) in a volume ratio of 1:1.

In this state, the polypropylene gasket 3 was fitted to the outer circumference of the negative electrode can 2, and the negative electrode can 2 was engaged with the positive electrode can 1 so that the organic electrolyte serving as the non-aqueous electrolyte was interposed between the positive electrode 4 and the negative electrode 5. The positive electrode can 1 was then crimped to complete the coin battery. With respect to battery dimensions, the diameter was 16 mm, and the thickness was 1.6 mm.

Battery B to Battery M were produced in the same manner as Battery A except that the active material was changed. The active material used in Battery B was Li_{0.44}MnO₂, which was prepared by mixing Na_{0.44}MnO₂ with a blend of LiNO₃ and LiOH and heating them in air for 5 hours to cause Na/Li exchange reaction to proceed. The active material used in Battery C was LiMn₂O₄, which was prepared by mixing LiOH and MnO₂ in a molar ratio of 1:2 and baking them at 650° C. for 5 hours. The active material used in Battery D was Li_{1.1}Mn_{1.85}B_{0.05}O₄, which was prepared by mixing LiOH, MnO₂, and B₂O₃ in a molar ratio of 0.55:0.925:0.025 and baking them at 650° C. for 5 hours. The active material used in Battery E was Li_{4/3}Mn_{5/3}O₄, which was prepared by mixing LiOH and MnO₂ in a molar ratio of 0.8:1 and baking them at 450° C. for 5 hours.

The active material used in Battery F was a lithium-containing manganese oxide comprising a mixed crystal of a lithiated ramsdellite-type manganese oxide and LiMn₂O₄ prepared by mixing LiOH and MnO₂ in a molar ratio of 1:1 and baking them at 450° C. for 5 hours. The active material used in Battery G was a mixture of Li_{1/3}MnO₂ of Battery A and LiMn₂O₄ of Battery C in a molar ratio of 1:1.

The active material used in Battery H was a mixture of LiMn₂O₄ of Battery E and LiCoO₂ in a molar ratio of 9:1. The active material used in Battery I was a mixture of LiMn₂O₄ and LiNiO₂ in a molar ratio of 9:1. The active material used in Battery J was a mixture of LiMn₂O₄ and LiCO_{0.5}Ni_{0.5}O₂ in a molar ratio of 9:1. The active material used in Battery K was a mixture of LiMn₂O₄ and LiCO_{1/3}Ni_{1/3}Mn_{1/3}O₂ in a molar ratio of 9:1.

The active material used in Battery L was a mixture of LiMn₂O₄ of Battery E and WO₃ in a molar ratio of 9:1. The active material used in Battery M was a mixture of LiCoO₂ and WO₃ in a molar ratio of 5:5.

In order to compare these batteries with a conventional battery, a comparative battery was produced in the same manner as Battery A except that LiMn₂O₄ was used as the positive electrode active material and that natural graphite was used as the negative electrode active material.

Battery A to Battery M were charged to 1.5 V at a constant current of 0.5 mA and then discharged to 0.5 V at a constant current of 0.5 mA to measure the initial discharge capacity. The comparative battery was charged to 4.2 V at a constant current of 0.5 mA and then discharged to 2.5 V at a constant current of 0.5 mA to measure the initial discharge capacity.

Thereafter, Battery A to Battery M and the comparative battery were externally short-circuited in a 60° C. atmosphere and then allowed to stand for 20 days. Battery A to Battery M were then charged to 1.5 V at a constant current of 0.5 mA and discharged to 0.5 V at a constant current of 0.5 mA to measure the discharge capacity after the test. The comparative battery was charged to 4.2 V at a constant current of 0.5 mA and then discharged to 2.5 V at a constant current of 0.5 mA to measure the discharge capacity. With the initial discharge capacity of each battery defined as 100, the discharge capacity after the test was calculated. The results are shown in Table 1.

TABLE 1

| | | Discharge |
|---|---|---|
| | | capacity |
| | | after test |
| Battery | Active material | (%) |
| A | Li_{1/3}MnO₂ | 98 |
| B | Li_{0.44}MnO₂ | 97 |
| C | LiMn₂O₄ | 95 |
| D | Li_{1.1}Mn_{1.85}B_{0.05}O₄ | 96 |
| E | Li_{4/3}Mn_{5/3}O₄ | 97 |
| F | Mixed crystal of lithiated ramsdellite Mn oxide | 99 |
| | and LiMn₂O₄ | |
| G | 1:1 mixture of LiMn₂O₄ and Li_{1/3}MnO₂ | 97 |
| H | 9:1 mixture of LiMn₂O₄ and LiCoO₂ | 95 |
| I | 9:1 mixture of LiMn₂O₄ and LiNiO₂ | 93 |
| J | 9:1 mixture of LiMn₂O₄ and LiCo_{0.5}Ni_{0.5}O₂ | 94 |
| K | 9:1 mixture of | 96 |
| | LiMn₂O₄ and LiCo_{1/3}Ni_{1/3}Mn_{1/3}O₂ | |
| L | 9:1 mixture of LiMn₂O₄ and WO₃ | 98 |
| M | 5:5 mixture of LiCoO₂ and WO₃ | 92 |
| Comparison | Positive electrode: LiMn₂O₄ | 79 |
| | Negative electrode: graphite | |

Positive electrode can: Ni/SUS304/Al
Negative electrode can: SUS316
Non-aqueous electrolyte: 1M LiPF₆/EC + DMC(1:1)

Battery A to Battery M, in which the positive electrode 4 and the negative electrode 5 have the active material of the same composition at the time of assembly, exhibited discharge capacities of 90% or more even after the short-circuit test. On the other hand, the comparative battery exhibited a large deterioration rate compared with Battery A to Battery M.

Next, Battery N to Battery S were produced in the same manner as Battery A except that the positive electrode can 1 and the negative electrode can 2 were made of the same material, and the material of the positive electrode can 1 and the negative electrode can 2 was examined using these batteries. The results are described below.

In Battery N, an aluminum cladding material of Ni/SUS304/Al was used for the positive electrode can 1 and the negative electrode can 2. In Battery O, SUS316 (Cr: 16.1% by weight, Mo: 2.0% by weight, Ni: 11.2% by weight, Fe: 69% by weight, pitting resistance equivalent: 22.7) was used for the positive electrode can 1 and the negative electrode can 2. In Battery P, SUS329J3L (Cr: 22.0% by weight, Mo: 3.1% by weight, Ni: 4.84% by weight, N: 0.10% by weight, Fe: 68.5% by weight, pitting resistance equivalent: 34.2) was used for the positive electrode can 1 and the negative electrode can 2.

In Battery Q, SUS444 (Cr: 18.5% by weight, Mo: 2.1% by weight, Fe: 77.8% by weight, pitting resistance equivalent: 25.4) was used for the positive electrode can 1 and the negative electrode can 2. In Battery R, a nickel alloy of Cr: 23.2% by weight, Mo: 7.4% by weight, Ni: 35.4% by weight, N: 0.22% by weight, and Fe: 33.4% by weight with a pitting resistance equivalent of 52.4 was used for the positive electrode can 1 and the negative electrode can 2. In Battery S, SUS304N (Cr: 18.2% by weight, Ni: 10.1% by weight, N: 0.12% by weight, Fe: 77.8% by weight, pitting resistance equivalent: 20.6) was used for the positive electrode can 1 and the negative electrode can 2.

Battery N to Battery S were subjected to the same test as that for Battery A to Battery M, and the results are shown in Table 2.

TABLE 2

| | | Discharge |
|---|---|---|
| | | capacity |
| | Positive electrode can/ | after test |
| Battery | negative electrode can | (%) |
| N | Ni/SUS304/Al | 98 |
| O | SUS316 | 90 |
| P | SUS329J3L | 92 |
| Q | SUS444 | 91 |
| R | Ni alloy | 93 |
| S | SUS304N | 80 |

Active material: Li_{1/3}MnO₂
Non-aqueous electrolyte: 1M LiPF₆/EC + DMC (1:1)

In the results of Table 2, Battery N to Battery R exhibited significantly high discharge capacities even after the external short-circuit test. On the other hand, Battery S exhibited a slight decrease in capacity. The pitting resistance equivalent of SUS304N used for the positive electrode can 1 and the negative electrode can 2 of Battery S is 20.6, which is slightly low. Probably for this reason, it is believed that the inner faces of the positive electrode can 1 and the negative electrode can 2 became slightly corroded in the external short-circuit test. It is believed that the corrosion resulted in poor current collection between the positive electrode 4 and the positive electrode can 1 and between the negative electrode 5 and the negative electrode can 2, and caused the components of the positive electrode can 1 and the negative electrode can 2 to be dissolved, thereby affecting the active material.

Next, using Batteries T, U, a1, and a2, the composition of organic electrolyte and solute concentration were examined, and the results are described below. First, the configuration of Battery T is described. In the coin battery illustrated in FIG. 1, stainless steel SUS444 (pitting resistance equivalent: 25.4) was used for the positive electrode can 1 and the negative electrode can 2, and polyether ether ketone was used for the gasket 3. A solution of butyl rubber diluted with toluene was applied between the positive electrode can 1 and the gasket 3 and between the negative electrode can 2 and the gasket 3, and the toluene was evaporated to provide butyl rubber sealants.

A solution prepared by dissolving 1.5M LiN(CF₃SO₂)₂ in sulfolane (SLF) was used as the organic electrolyte.

LiMn₂O₄, which was the same as that for Battery C, was used for the electrode mixture. This electrode mixture was molded into pellets of 2.3 mm in diameter under a pressure of 0.1 ton/cm², and dried at 250° C. in air to obtain the positive electrode 4 and the negative electrode 5. The weight ratio of the positive electrode 4 to the negative electrode 5 was 1.1:1. That is, the weight of the positive electrode 4 was 1.1 times that of the negative electrode 5.

With the above-mentioned configuration, Battery T with a diameter of 4.8 mm and a thickness of 1.4 mm was produced. A terminal was laser welded to each of the positive electrode can 1 and the negative electrode can 2.

In Battery U, a solvent mixture of tetraglyme (TG) and diglyme (DG) in a volume ratio of 3:7 was used as the solvent of the organic electrolyte instead of sulfolane. Except for this, Battery U was produced in the same manner as Battery T. In Battery a1, the concentration of LiN(CF₃SO₂)₂ was adjusted to 1.25 M. Except for this, Battery a1 was produced in the same manner as Battery T. In Battery a2, the concentration of LiN(CF₃SO₂)₂ was adjusted to 1.0 M. Except for this, Battery a2 was produced in the same manner as Battery T. In Battery a3, the weight ratio of the positive electrode to the negative electrode was set to 1:1. Except for this, Battery a3 was produced in the same manner as Battery a1. In Battery a4, the weight ratio of the positive electrode to the negative electrode was set to 1:1.1. Except for this, Battery a4 was produced in the same manner as Battery a1.

Batteries T, U, a1, a2, a3, and a4 thus produced were passed through a reflow furnace. The reflow conditions were as follows. The temperature of the preheat zone was set to 150° C., and the passing time was set to 2 minutes. In the reflow zone, the temperature was changed every about 80 seconds in the order of 180° C.→250° C.→180° C.

The voltages of Battery T and Battery U before the mounting were 0.004 V and 0.003 V, respectively, since they were not charged/discharged after the battery assembly. The voltages of Batteries a1, a2, a3, and a4 were also 0.1 V or less.

After the mounting, the respective batteries were charged at a charge voltage of 1.5 V and a charge protection resistance of 3 kΩ. Further, they were discharged to 0.5 V at a constant current of 0.005 mA to measure the discharge capacity after the reflowing. Meanwhile, Batteries T, U, a1, a2, a3, and a4 were additionally prepared, and without being passed through the reflow furnace, they were charged/discharged under the above-mentioned conditions to measure the initial discharge capacity. With the initial discharge capacity defined as 100, the ratio of the discharge capacity after the reflowing was calculated.

Also, the respective batteries were mounted by reflowing such that the positive electrode side and the negative electrode side were reversed, and they were charged/discharged under the above-mentioned conditions. After this reverse charge test, they were charged/discharged under the above conditions to measure the discharge capacity. With the initial discharge capacity defined as 100, the ratio of the discharge capacity after the reverse charge test was calculated. The results are shown in Table 3.

TABLE 3

| | | | | | | Discharge |
|---|---|---|---|---|---|---|
| | | | | Weight ratio | Discharge | capacity |
| | | | | of positive | capacity | after |
| | | | | electrode to | after | reverse |
| | Electrolyte | | | negative | reflowing | charging |
| Battery | Solvent | Solute | Concentration (M) | electrode | (%) | (%) |
| T | SLF | LiN(CF₃SO₂)₂ | 1.5 | 1.1:1 | 97 | 83 |
| U | TG:DG | LiN(CF₃SO₂)₂ | 1.5 | 1.1:1 | 95 | 82 |
| | (3:7) | | | | | |
| a1 | SLF | LiN(CF₃SO₂)₂ | 1.25 | 1.1:1 | 98 | 84 |
| a2 | SLF | LiN(CF₃SO₂)₂ | 1.0 | 1.1:1 | 97 | 85 |
| a3 | SLF | LiN(CF₃SO₂)₂ | 1.25 | 1:1 | 97 | 97 |
| a4 | SLF | LiN(CF₃SO₂)₂ | 1.25 | 1:1.1 | 98 | 95 |

Active material: LiMn₂O₄,
SLF: sulfolane
TG: tetraglyme,
DG: diglyme

Even after the reflow mounting, Batteries T, U, a1, a2, a3, and a4 exhibited high capacity retention rates. Also, even after the reverse charging, they exhibited capacities of 80% or more without leakage. In this way, batteries using SLF, TG, and DG as the solvent can maintain their discharge capacities even upon exposure to high temperatures by reflowing. Also, by forming a battery using an active material of the same composition for the positive electrode 4 and the negative electrode 5, it is possible to provide a battery that can withstand reverse charging.

Next, examinations were made by using sulfolane as the solvent of the organic electrolyte, adjusting the concentration of LiN(CF₃SO₂)₂ to 1.25 M, using a mixture of LiMn₂O₄ and LiCoO₂ as the active material, and varying the mixing ratio of LiMn₂O₄ to LiCoO₂, and the results are described below.

In Battery b1 to Battery b4, the concentration of LiN(CF₃SO₂)₂ was adjusted to 1.25 M, and the ratios of LiMn₂O₄ to LiCoO₂ were set to 9:1, 8:2, 7:3, and 5:5, respectively. Except for this, Battery b1 to Battery b4 were produced in the same manner as Battery a3.

Battery b1 to Battery b4 thus produced were evaluated in the same manner as Battery a3, and the results are shown in Table 4.

TABLE 4

| | | | Discharge |
|---|---|---|---|
| | | | capacity after |
| | Mixing ratio of | Discharge capacity | reverse |
| | active materials | after reflowing | charging |
| Battery | (LiMn₂O₄:LiCoO₂) | (%) | (%) |
| b1 | 9:1 | 97 | 95 |
| b2 | 8:2 | 98 | 94 |
| b3 | 7:3 | 97 | 93 |
| b4 | 5:5 | 96 | 96 |

Non-aqueous electrolyte: 1.25M LiN(CF₃SO₂)₂/SLF

Next, examinations were made by using a mixture of LiMn₂O₄ and LiCO_{1/3}Ni_{1/3}Mn_{1/3}O₂ as the active material and varying the mixing ratio of LiMn₂O₄ to LiCo_{1/3}Ni_{1/3}Mn_{1/3}O₂, and the results are described below.

In Battery c1 to Battery c4, the mixing ratios of LiMn₂O₄ to LiCO_{1/3}Ni_{1/3}Mn_{1/3}O₂ were set to 9:1, 8:2, 7:3, and 5:5, respectively. Except for this, Battery c1 to Battery c4 were produced in the same manner as Battery b1.

Battery c1 to Battery c4 thus produced were evaluated in the same manner as Battery a3, and the results are shown in Table 5.

TABLE 5

| | | | Discharge |
|---|---|---|---|
| | | Discharge | capacity |
| | Mixing ratio of | capacity after | after reverse |
| | active materials | reflowing | charging |
| Battery | LiMn₂O₄:LiCo_{1/3}Ni_{1/3}Mn_{1/3}O₂ | (%) | (%) |
| c1 | 9:1 | 97 | 96 |
| c2 | 8:2 | 97 | 95 |
| c3 | 7:3 | 98 | 97 |
| c4 | 5:5 | 96 | 94 |

Electrolyte: 1.25M LiN(CF₃SO₂)₂/SLF

In the results of Table 4 and Table 5, Batteries b1 to b4 and Batteries c1 to c4 exhibited high capacity retention rates even after the reflow mounting. Also, even after the reverse charging, they exhibited capacities of 80% or more without leakage. In this way, the batteries using sulfolane as the solvent of the organic electrolyte can maintain their discharge capacities even upon exposure to high temperatures by reflowing, regardless of the mixing ratio of the active materials. It should be noted that with respect to Batteries b1 to c4 using the mixtures of active materials, the results shown were obtained when the salt concentration of the electrolyte was 1.25 M, but the essentially the same results were obtained at 1.0 M and 1.5 M as well.

Next, examinations were made by using an active material of Li_{1.1}Mn_{1.9}O₄, which is different from that of Battery a3 in the composition ratios of Li and Mn, and the results are described below. Battery d1 was produced in the same manner as Battery a1 except for the use of Li_{1.1}Mn_{1.9}O₄ as the active material. Battery d1 obtained was evaluated in the same manner as Battery T, and the results are shown in Table 6 together with the results of Battery a1.

TABLE 6

| | | Discharge | Discharge |
|---|---|---|---|
| | | capacity after | capacity |
| | | reflowing | after reverse |
| Battery | Active material | (%) | charging (%) |
| a1 | LiMn₂O₄ | 97 | 97 |
| d1 | Li_{1.1}Mn_{1.9}O₄ | 98 | 90 |

Electrolyte: 1.25M LiN(CF₃SO₂)₂/SLF

In the results of Table 6, Batteries d1 exhibited a high capacity retention rate even after the reflow passing.

Also, even after the reverse charging, it exhibited a capacity of 80% or more without leakage. In this way, regardless of the composition ratios of Li and Mn, the battery according to this embodiment has a high reflow resistance and a high reverse charge resistance.

In these tests, batteries before being charged/discharged were subjected to reflowing, but batteries charged and discharged to a voltage of 0.1 V or less can also produce essentially the same effects.

Next, the examination results of the non-aqueous electrolyte secondary battery of FIG. 2 having symmetrical positive and negative electrode cans are described. The electrodes 11 of the same configuration (weight and shape) containing LiMn₂O₄ of Battery C were bonded to the exterior cans 9 made of aluminum. The electrodes 11 were disposed so as to face each other with the separator 12 containing an organic electrolyte interposed therebetween. They were sealed by thermally welding the insulating sealing member 10 made of polyethylene, to produce the symmetrical battery. The organic electrolyte used was a solution of the same composition and concentration as that of Battery A. With this configuration, Battery V was produced.

Battery V was charged at a charge voltage of 1.5 V and a charge protection resistance of 3 kΩ and then discharged to 0.5 V at a constant current of 0.005 mA to measure the discharge capacity. Also, with the polarity reversed, it was charged/discharged under the above conditions in the same manner to measure the discharge capacity. The ratio between the discharge capacities according the two charge/discharge methods was calculated and turned out to be 1. That is, even when the polarity was reversed, Battery V exhibited the same discharge capacity. In this way, even if plus and minus of a symmetrical non-aqueous electrolyte secondary battery are connected reversely, its characteristics are not affected. This offers a wide choice of methods of connecting batteries to devices and more freedom of device design or shape.

In this embodiment, mainly a coin shape has been described, but this is not to be construed as limiting. Cylindrical, rectangular, aluminum laminated, and other shapes may also produce essentially the same results.

### INDUSTRIAL APPLICABILITY

The non-aqueous electrolyte secondary battery according to the present invention has high productivity, is stable even when reversely charged in a device, and is capable of simplifying the substrate design of the device. Its industrial value is very high.

1. A non-aqueous electrolyte secondary battery, comprising;
a positive electrode comprising an active material capable of reversibly absorbing and desorbing lithium;
a negative electrode comprising an active material of the same composition as that of said active material of said positive electrode; and
a non-aqueous electrolyte interposed between said positive electrode and said negative electrode.

2. The non-aqueous electrolyte secondary battery in accordance with claim 1, wherein said non-aqueous electrolyte comprises at least one of sulfolane, 3-methylsulfolane, tetraglyme, and diglyme.

3. The non-aqueous electrolyte secondary battery in accordance with claim 1, wherein said active material comprises a lithium-containing manganese oxide.

4. The non-aqueous electrolyte secondary battery in accordance with claim 1, wherein said active material comprises a mixed crystal of two or more lithium-containing manganese oxides or a mixture of two or more lithium-containing manganese oxides.

5. The non-aqueous electrolyte secondary battery in accordance with claim 1, wherein said active material comprises at least one of LiCoO₂, LiNiO₂, LiNiₓCo_{1-X}O₂(0<X<1), and LiCo_{1/3}Ni_{1/3}Mn_{1/3}O₂.

6. The non-aqueous electrolyte secondary battery in accordance with claim 1, further comprising a positive electrode can connected to said positive electrode, and a negative electrode can connected to said negative electrode,
wherein said positive electrode can and said negative electrode can form exterior cans that seal said positive electrode, said negative electrode, and said non-aqueous electrolyte, and
said positive electrode can and said negative electrode can are made of a material of the same composition.

7. The non-aqueous electrolyte secondary battery in accordance with claim 1, further comprising a positive electrode can connected to said positive electrode, and a negative electrode can connected to said negative electrode,
wherein said positive electrode can and said negative electrode can form exterior cans that seal said positive electrode, said negative electrode, and said non-aqueous electrolyte, and
said exterior cans are composed of one of aluminum, an aluminum alloy, a cladding material of aluminum and stainless steel, and a cladding material of an aluminum alloy and stainless steel.

8. The non-aqueous electrolyte secondary battery in accordance with claim 1, further comprising a positive electrode can connected to said positive electrode, and a negative electrode can connected to said negative electrode,
wherein said positive electrode can and said negative electrode can form exterior cans that seal said positive electrode, said negative electrode, and said non-aqueous electrolyte, and
said exterior cans are composed of an alloy containing at least one of iron, nickel, and chromium and having a pitting resistance equivalent of 22 or more.

9. The non-aqueous electrolyte secondary battery in accordance with claim 1, further comprising a positive electrode can connected to said positive electrode, and a negative electrode can connected to said negative electrode,
wherein said positive electrode can and said negative electrode can form exterior cans that seal said positive electrode, said negative electrode, and said non-aqueous electrolyte, and
said positive electrode can and said negative electrode can are symmetrical.

10. A method for producing a non-aqueous electrolyte secondary battery comprising the steps of:
preparing a positive electrode comprising an active material capable of reversibly absorbing and desorbing lithium;
preparing a negative electrode comprising an active material of the same composition as that of said active material of said positive electrode;
interposing a non-aqueous electrolyte between said positive electrode and said negative electrode; and
charging said positive electrode and said negative electrode to generate a voltage therebetween.

11. A method for mounting a non-aqueous electrolyte secondary battery, comprising the steps of:
mounting a non-aqueous electrolyte secondary battery on a substrate by reflowing, said battery comprising: a positive electrode comprising an active material capable of reversibly absorbing and desorbing lithium; a negative electrode comprising an active material of the same composition as that of said active material of said positive electrode; and a non-aqueous electrolyte interposed between said positive electrode and said negative electrode, said battery having a voltage of 0.1 V or less; and
charging the mounted non-aqueous electrolyte secondary battery.
